(19) United States
(12) Patent Application Publication
(10) Pub. No.: US 2004/0240498 A1
(43) Pub. Date: Dec. 2, 2004

(54) Semiconductor laser module and its heat releasing method and image display apparatus

(75) Inventors: Naoki Akamatsu, Kumagaya-shi (JP); Kazuyoshi Fuse, Fukaya-shi (JP); Tooru Sugiyama, Kumagaya-shi (JP); Ko Sato, Fukaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/806,351

(22) Filed: Mar. 23, 2004

(30) Foreign Application Priority Data
Apr. 25, 2003 (JP) 2003-121582

(51) Int. Cl. H01S 3/04

(52) U.S. Cl. 372/36; 372/34

(57) ABSTRACT

A semiconductor laser module comprising, a semiconductor laser element, an electronic cooling element configured to allow heat from the semiconductor laser element to be transmitted thereto, a heat sink configured to allow the heat which is transmitted to the electronic cooling element to be released, an optical system configured to conduct a laser beam which is emitted from the semiconductor laser element to an optical fiber cable, and a heat resistance section configured to transmit the heat of the optical system to the electronic cooling element, having a heat resistance greater than a heat resistance when the heat of the semiconductor laser element is transmitted to the electronic cooling element.

### CROSS-REFERENCE TO RELATED APPLICATIONS

This application is based upon and claims the benefit of priority from prior Japanese Patent Application No. 2003-121582, filed Apr. 25, 2003, the entire contents of which are incorporated herein by reference.

### BACKGROUND OF THE INVENTION

1. Field of the Invention

The present invention relates to a semiconductor laser module using a high-output semiconductor laser element and its heat releasing method. Further, the present invention relates to a projection type image display apparatus using the semiconductor laser module as light source.

2. Description of the Related Art

As well known in the field such as optical communications, a semiconductor laser element has been widely adopted as a light source. In this case, the semiconductor laser element is modularized as a unit integral with an optical system for optically coupling its exiting light to an optical fiber cable.

Incidentally, generally, when a semiconductor laser element is placed under a higher ambient temperature environment or a higher temperature is generated at a time of its driving, there occurs a fall in light output, which results in a shorter service life. In the semiconductor laser module, therefore, a heat releasing mechanism is provided for the semiconductor laser element.

Jpn. Pat. Appln. KOKAI Publication No. 2002-50824 discloses a heat releasing mechanism configured to release heat to an outside by allowing heat, which is generated in a semiconductor laser element, to be transmitted through an electronic cooling element such as a Peltier element, to a casing containing the semiconductor laser element and optical system.

In this heat releasing mechanism, the amount of electric current passed into the electronic cooling element is controlled based on an output value of a temperature sensor such as a thermistor, to maintain the temperature of the semiconductor laser element constant and, by doing so, the temperature of the semiconductor laser element is controlled.

In the case where use is made of a semiconductor laser module placed in a high ambient temperature state, a current is carried through the electronic cooling element before the driving of the semiconductor laser element and, by doing so, the temperature of the semiconductor laser element is lowered to a steady-state operation temperature.

In a state in which the temperature of the semiconductor laser element reaches a steady-state operation level, the semiconductor laser element is driven and it is possible to obtain a rated light output from the semiconductor laser element without impairing the life of the semiconductor laser element.

In the heat releasing mechanism disclosed in the above-mentioned KOKAI Publication, even the optical system for optically coupling the exited light of the semiconductor laser element to an optical fiber cable has its temperature controlled by the electronic cooling element to set it to be constant. In this case, both the semiconductor laser element and optical system have to be cooled by the electronic cooling element, which involves an excessive heat capacity.

As set out above, if the semiconductor laser element is driven under a condition that the semiconductor laser module is placed in a high ambient temperature state, electric current is carried through the electronic cooling element to allow the semiconductor laser element to cool down. In this case, it takes a longer time to lower the semiconductor laser element down to a steady-state operation temperature. This presents a problem.

In order to deal with the problem, various proposals may be made, such as controlling the temperature of a semiconductor laser element at a normal time by carrying electric current through an electronic cooling element even when the semiconductor laser element is not used, or using an electronic cooling element having a very large temperature absorbing capacity to lower the temperature of a semiconductor laser element in a short period of time. However, these proposals are not suitable from a practical viewpoint.

It is to be noted that an optical system for conducting the exited light of the semiconductor laser element to an optical fiber cable and a support member for supporting the optical fiber cable are thermally expanded under a high ambient temperature to cause a displacement of a relative position among the semiconductor laser element, optical system and optical fiber. If this occurs, a sufficient supply of the exited light from the semiconductor laser element to the optical fiber cable is not made, so that a light output of the semiconductor laser module as a whole is lowered.

From a practical viewpoint, therefore, not only the semiconductor laser element but also the optical system itself and support member for supporting the optical system and optical fiber cable need to be temperature-controlled by means of the electronic cooling element.

In the present time, intense research has been carried out in the use of this type of semiconductor laser module as a light source for a projection type image display device such as a projector. In this case, use is made, as a semiconductor laser element, of a one capable of generating a light output as high as several W to 10W.

In the case where such a semiconductor laser module is used for a general consumer home electric appliance, a strong demand is made for lowering the temperature of the semiconductor laser element in a short time down to a steady-state operation level, even when such a home electric appliance is allowed to stand under a higher ambient temperature such as in the summer season, and, by doing so, placing the home electric appliance in a readily available state. Demands are also made for saving electric power at a standby time, and so on.

Jpn. Pat. Appln. KOKAI Publication No. 2001-284700 discloses a high-output semiconductor laser module of less dissipation power which can release more heat from a semiconductor laser element.

Jpn. Pat. Appln. KOKAI Publication No. 2001-133664 discloses a semiconductor laser module for obtaining a high coupling rate while assuring less damage to the semiconductor laser element and to the optical fiber unit.

Jpn. Pat. Appln. KOKAI Publication No. 2000-349386 discloses a high output semiconductor laser module usable under high ambient temperatures.

In these three KOKAI Publications, however, no mention is made of the concept of dealing with problems that occur when the semiconductor laser module is driven under a high ambient temperature condition, nor meeting the requirements involved when the semiconductor laser module is applied to home electric appliances.

### BRIEF SUMMARY OF THE INVENTION

According to one aspect of the present invention, there is provided a semiconductor laser module comprising: a semiconductor laser element; an electronic cooling element configured to allow heat from the semiconductor laser element to be transmitted thereto; a heat sink configured to allow the heat which is transmitted to the electronic cooling element to be released; an optical system configured to conduct a laser beam which is emitted from the semiconductor laser element to an optical fiber cable; and a heat resistance section configured to transmit the heat of the optical system to the electronic cooling element, having a heat resistance greater than a heat resistance when the heat of the semiconductor laser element is transmitted to the electronic cooling element.

According to one aspect of the present invention, there is provided a method for releasing heat from a semiconductor laser module configured to allow heat of a semiconductor laser element, as well as heat of an optical system configured to conduct a laser beam which is emitted from the semiconductor laser element to an optical fiber cable, to be released through an electronic cooling element to a heat sink, comprising: detecting a temperature of the semiconductor laser element; turning the electronic cooling element ON in a state in which the detected temperature of the semiconductor laser element is higher than a steady-state operation temperature; at a starting time of carrying electric current to the electronic cooling element, absorbing the heat of the semiconductor laser element into the electronic cooling element in preference to the heat of the optical system; and driving the semiconductor laser element in a state in which the temperature of the semiconductor laser element reaches the steady-state operation temperature.

According to one aspect of the present invention, there is provided an image display apparatus comprising: a semiconductor laser module configured to allow heat of a semiconductor laser element to be released through an electronic cooling element to a heat sink and allow heat of an optical system to be transmitted to the electronic cooling element through a heat resistance section having a heat resistance greater than a heat resistance when the heat of the semiconductor laser element is transmitted to the electronic cooling element, the optical system being configured to allow a laser beam which is emitted from the semiconductor laser element to be conducted to an optical fiber cable; a modulation section configured to space-modulate a laser beam which is outputted through the optical fiber from the semiconductor laser module on the basis of a video signal; and a display section configured to projection-display the light output which is obtained from the modulation section onto a screen.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a first embodiment of the present invention as explained in connection with a liquid crystal projection TV receiver;

FIG. 2 is a side view in cross-section shown to explain a structure of a semiconductor laser module in the first embodiment;

FIG. 3 is a perspective, exploded view showing a detail of an essential section of the semiconductor laser module in the first embodiment;

FIG. 4 is a flow chart for explaining an image display operation at a time of driving the liquid crystal projection TV receiver in the first embodiment;

FIGS. 5A and 5B are characteristic curves for explaining temperature variation of a semiconductor laser element and optical system at a time of driving the liquid crystal projection TV receiver in the first embodiment and a variation of the light output of the semiconductor laser module;

FIG. 6 shows a second embodiment of the present invention as explained in connection with a structure of a semiconductor laser module;

FIG. 7 is a view for explaining a detailed structure of a second heat spreader in the second embodiment; and

FIG. 8 shows a third embodiment of the present invention as explained in connection with a structure of a semiconductor laser module.

### DETAILED DESCRIPTION OF THE INVENTION

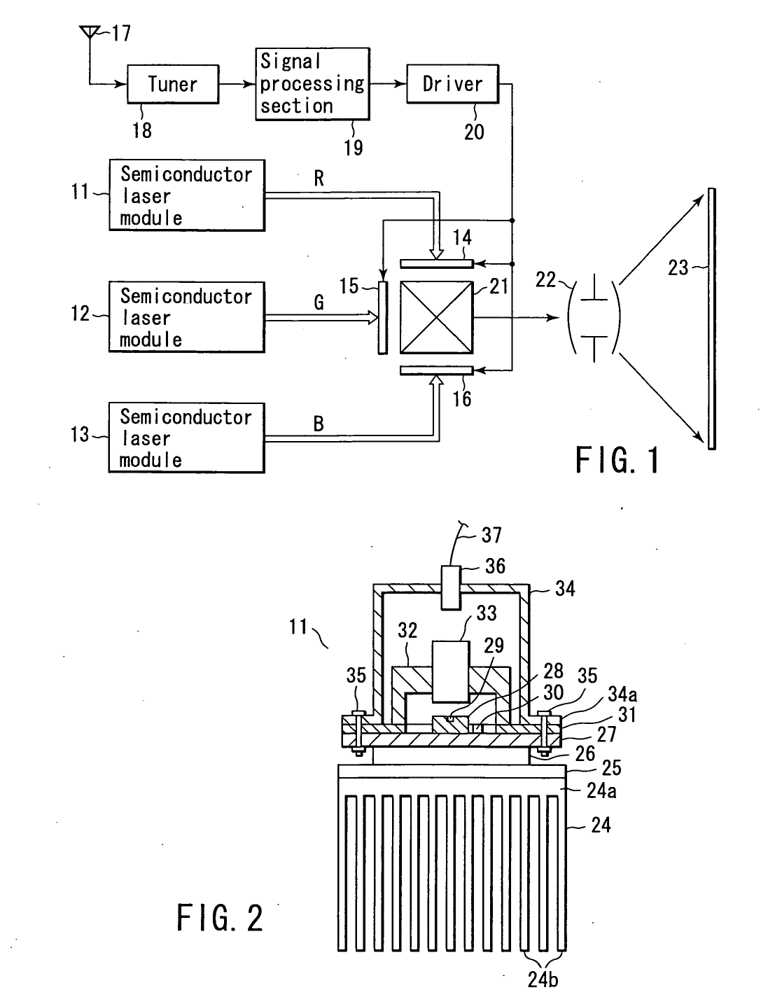

With reference to the drawing, an explanation will be made in more detail below about a first embodiment of the present invention. FIG. 1 shows a liquid crystal projection TV (television) receiver as an image display device explained in connection with the first embodiment.

In FIG. 1, reference numerals 11, 12 and 13 show semiconductor laser modules. These semiconductor laser modules 11, 12 and 13 emit red (R), green (G) and blue (B) laser beams, respectively.

The R, G and B laser beams emitted from the respective semiconductor laser modules, 11, 12 and 13 enter liquid crystal panels 14, 15 and 16, respectively, constituting space modulation means arranged in a manner to correspond to these laser beams.

On the other hand, a TV broadcasting signal which is received by an antenna 17 is channel-selected at a tuner 18 and then demodulated at a signal processing section 19 to provide a video signal. This video signal is inputted through a driver 20 to the respective liquid crystal panels 14, 15 and 16.

By doing so, the R, G and B laser beams incident on the respective liquid crystal panels 14, 15 and 16 are space-modulated by the video signal and synthesized by a synthesizing means such as a dichroic prism 21.

The resultant synthesized beam is projected by a projection lens 22 on a screen 23 on an enlarged form where a corresponding TV broadcasting image is displayed.

FIG. 2 shows a structure of the semiconductor laser module 11 as set out above. The other semiconductor laser modules 12 and 13, though different in their handling colors from the semiconductor laser module 11, have the same structure as that of the semiconductor laser module 11, so their further explanation is omitted.

In FIG. 2, reference numeral 24 shows a heat sink comprising a thin, substantially rectangular base section 24a and a plurality of heat releasing fins 24b arranged at given intervals as a parallel array and projected on one face side of the base section 24a.

A first heat spreader 25 is formed as having a substantially flat plate-like configuration and has one face making contact with the other face of the base section 24a of the heat sink 24. And a Peltier element 26 constituting an electronic cooling element is formed as having a substantially flat plate-like configuration and has one face making contact with the other face of the first heat spreader 25.

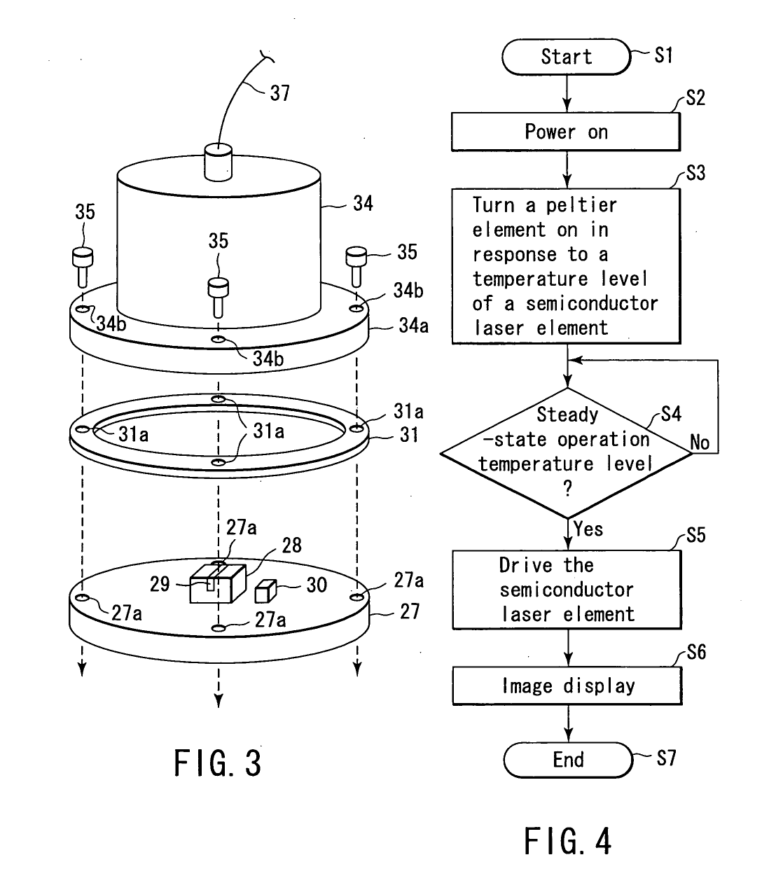

As shown in FIG. 3, a second heat spreader 27 is formed to have a substantially disk-like configuration and has one face making contact with the other face of the Peltier element 26. A semiconductor laser element 29 is positioned by a mount 28 at a central portion of the other face of the second heat spreader 27.

The semiconductor laser element 29 emits a R laser beam. A temperature sensor 30 is arranged on the other face side of the second heat spreader 27 and set near the semiconductor laser element 29 to detect its temperature. In a peripheral edge portion of the second heat spreader 27, four through holes 27a are formed at equal intervals.

Here, the Peltier element 26 is driven such that a heat absorption side serves as a lower temperature side set in contact with the second heat spreader 27 and a heat releasing side serves as a high temperature side set in contact with the first heat spreader 25.

A high heat resistance element 31 is formed to have a ring-like configuration on the peripheral edge portion side of the second heat spreader 27 and has one face making contact with the other face of the second heat spreader 27. The high heat resistance element 31 is made of a metal, ceramics, etc., having a smaller heat conductivity.

In this case, the high heat resistance element 31 is so set as to have a heat resistance greater than a heat resistance involved when a heat of the semiconductor laser element 29 is transmitted to the Peltier element 26 through the second heat spreader 27.

Further, through holes 31a are provided in the high heat resistance element 31 at the places corresponding to the through holes 27a of the second heat spreader 27.

One end of a substantially cylindrical holder 32 is fixed to the other end face of the high heat resistance element 31 and situated at an inner circumferential side portion of the element 31. A light coupling system 33 is supported at the other end of the holder 32.

A substantially cylindrical casing 34 is so provided as having a flange 34a at its one end face. The flange 34a is set in contact with the other end face side, that is, the outer peripheral side portion of the high heat resistance element 31. The flange 34a has through holes 34b formed at positions corresponding to the through holes 27a of the second heat spreader 27.

By inserting each screw 35 into the corresponding through hole 34b of the casing 34, through hole 31a of the high heat resistance element 31 and through hole 27a of the second heat spreader 27, the casing 34, the high heat resistance element 31 and second heat spreader 27 are fixed together as an integral unit. The screw 35 is made of a resin having a smaller heat conductivity.

Here, an optical fiber cable 37 is supported by a ferrule 36 at the other end of the casing 34. A laser beam which is emitted from the semiconductor laser element 29 enters the optical fiber cable 37 in the ferrule 36 through the light coupling system 33 and it is outputted to the corresponding liquid crystal panel 14.

This optical coupling system 33 is comprised of a plurality of lenses and allows the laser beam which is emitted from the semiconductor laser element 29 to be condensed and shaped and a resultant laser beam to enter the core of the optical fiber 37.

Here, the heat possessed by the semiconductor laser element 29 under an ambient temperature or the heat generated by the semiconductor laser element 29 itself is transmitted through the mount 28 to the second heat spreader 27 where the heat involved is effectively spread.

The heat spread by the second heat spreader 27 is absorbed by the heat absorption side of the Peltier element 26 and transmitted through the heat releasing side of the Peltier element 26 to the first heat spreader 25 where it is effectively spread. After this, the heat spread by the first heat spreader 25 is released to an outside through the heat sink 24.

On the other hand, the heat under the ambient temperature which is possessed by an optical system including the holder 32, optical coupling system 33, casing 34, ferrule 36, etc., is released by the heat sink 24 to the outside after passing through the high heat resistance element 31 and then through the second heat spreader 27, Peltier element 26 and first heat spreader 25.

That is, in the semiconductor laser module 11 thus structured, the heat of the semiconductor laser element 29 is transmitted directly to the second heat spreader 27 and released, while, on the other hand, the heat involved in the optical system other than the semiconductor laser element 29 is transmitted through the high heat resistance element 31 to the second heat spreader 27.

An explanation will be made below about the case where, before the driving of the semiconductor laser element 29, electric current is carried from a Peltier element's drive power supply not shown to the Peltier element 26 in the semiconductor laser module 11 placed under a high temperature condition.

The whole semiconductor laser module is set uniform in the ambient temperature, and a heat conduction amount is expressed by (higher temperature-lower temperature)/(heat resistance). Since, in this mathematic expression, the heat conduction amount in the region including the semiconductor laser element 29 and mount 28 and the heat conduction amount in the region including the optical system have the same numerator, the heat conduction amount in the former region is larger than that in the latter region.

Therefore, the heat contained in the semiconductor laser element 29 (and mount 28) is transmitted (absorbed) through the second heat spreader 27 into the Peltier element 26, so that the temperature of the semiconductor laser element 29 is quickly lowered.

On the other hand, the heat contained in the optical system such as the holder 32, optical coupling system 33, casing 34, ferrule 36, etc., since being transmitted through the high heat resistance element 31, is absorbed through the second heat spreader 27 into the Peltier element 26 in less heat conduction level, so that the temperature of the optical system becomes gradually lower than that of the semiconductor laser element 29.

That is, at a starting portion of the power supply, out of the heat absorbed by the Peltier element 26, more heat is coming primarily from the semiconductor laser element 29 (and mount 28) and less heat is coming from the optical system. After this, as the temperature of the semiconductor laser element 29 is lowered, the ratio of heat emitted from the semiconductor laser element (and mount 28) is lowered and the ratio of heat coming from the optical system is increased. The temperature of the semiconductor laser element 29 first reaches a predetermined level and the temperature of the optical system gradually approaches a predetermined operation level. In other words, the preferential temperature lowering of the semiconductor laser element 29 is accomplished.

As set out above, a heat capacity as a cooling target of the Peltier element 26 is divided into a portion corresponding to the semiconductor laser element 29 and mount 28 and a portion corresponding to the optical system. By interposing the high heat resistance element 31 on the optical system side it is possible to, without involving any excess of heat relative to the Peltier element 26 from a practical viewpoint, lower the temperature of the semiconductor laser element 29 down to a steady-state operation level and perform a driving operation in short time.

If, therefore, a liquid crystal projection TV receiver placed under a high ambient temperature condition is to be driven, it can be done so in such a state that the temperature of the semiconductor laser element 29 has been lowered down to the steady-state operation level in a short time. It is, therefore, possible to display an image promptly after the turning. ON of the power supply.

Further, since the Peltier element 26 is not under a normally-on state, it is possible to perform a driving operation with less standby power.

FIG. 4 is a flow chart showing the combined operation of an image display at a time of driving the liquid crystal projection TV receiver. Starting is made at step S1 and, at step S2, a power supply is rendered ON. At step S3, the Peltier element 26 conducts in accordance with the temperature of the semiconductor laser element 29 detected by the temperature sensor 30.

At step S4, a wait is made for the temperature of the semiconductor laser element 29 to be lowered down to a steady-state operation temperature. When the normal operation temperature is reached, the semiconductor laser element 29 is driven at step S5 and an image is displayed at step S6 and, step S7, the process is ended.

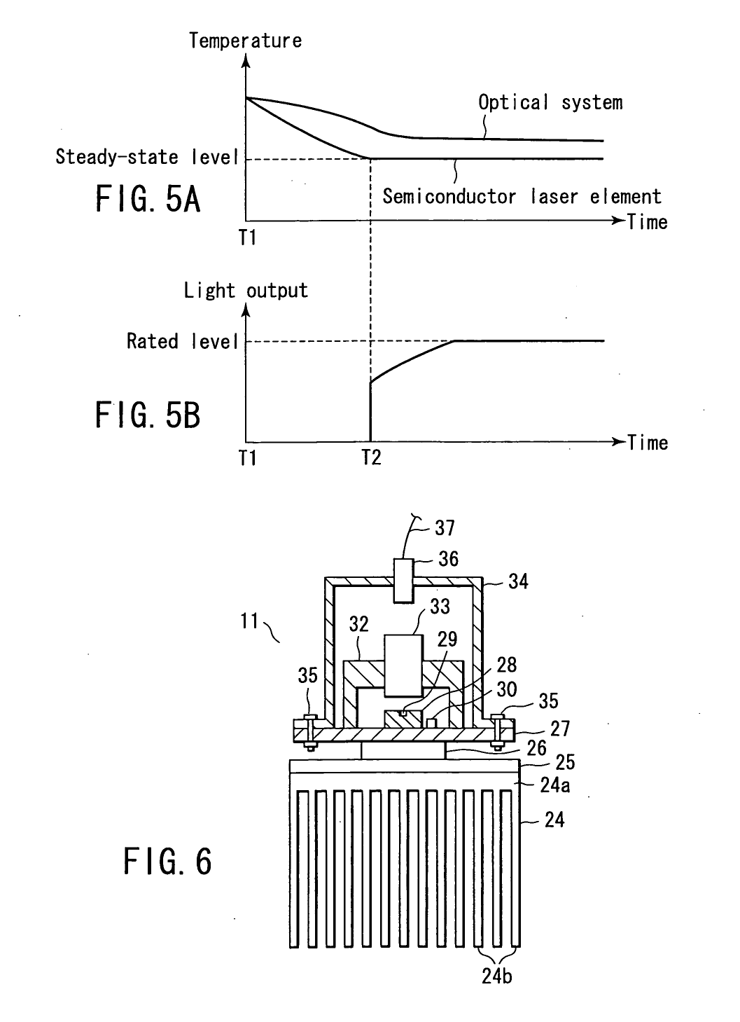

FIGS. 5A and 5B show a relation of the temperatures of the semiconductor laser element 29 and optical system to the light output of the semiconductor laser module 11. FIG. 5A shows the temperature variations of the semiconductor laser element 29 and optical system and FIG. 5B shows the variation of the light output of the semiconductor laser module 11.

First, at time T1 when the temperatures of the semiconductor laser element 29 and optical system become higher than their steady-state-temperature, if the Peltier element 26 is turned ON, then, as set out above, the releasing of heat relative to the semiconductor laser element 29 is done in preference to that of the optical system and the temperature of the semiconductor laser element 29 is rapidly lowered in comparison with the optical system.

At time T2 when the temperature of the semiconductor laser element 29 reaches a steady-date operation level, the semiconductor laser element 29 is driven and light is output from the semiconductor laser module 11.

Since, at time T2, the temperature of the optical system does not yet reach the steady-state operation level, the relative position among the semiconductor laser element 29, light coupling system 33 and optical fiber cable 37 may reveal some displacement. For this reason, the efficiency with which the laser beam emitted from the semiconductor laser element 29 enters the optical fiber cable 37 is lowered, thus producing an “un-rated” light output.

After a certain time, as the optical system approaches the rated temperature level by subsequent cooling, the light output from the semiconductor laser module 11 approaches a rated level.

Here, at time T2, the light output from the semiconductor laser module 11 does not reach a rated level and hence an image displayed on the screen 23 is lower in luminance than at a steady-state level, that is, an image appears dark on the screen.

However, a prompt image display response, even if an image being lower in luminance level than in the case where nothing is displayed on the screen until the semiconductor laser element 29 and optical system reach a steady-state temperature level, is preferable as a liquid crystal projection TV receiver which serves as a home electric appliance.

It is to be noted that the areas of the holder 32 and casing 34 which make contact with the high heat resistance element 31 are so located as to be symmetric about an optical axis of the optical coupling system 33 and ferrule 36. Even if there occurs any temperature variation, the optical axis is not displaced in a direction orthogonal thereto.

An explanation will now be made about a second embodiment of the present invention. The second embodiment shows another practical form for transmitting heat of a semiconductor laser element 29 (and mount 28) to a Peltier element 26 in preference to the case of transmitting heat of an optical system to that element 26.

In FIG. 6, the same reference numerals are employed to designate parts or elements corresponding to those shown in FIG. 2. In a structure in FIG. 6, a high heat resistance element 31 is not used, and a holder 32 and casing 34 are mounted directly to a second heat spreader 27.

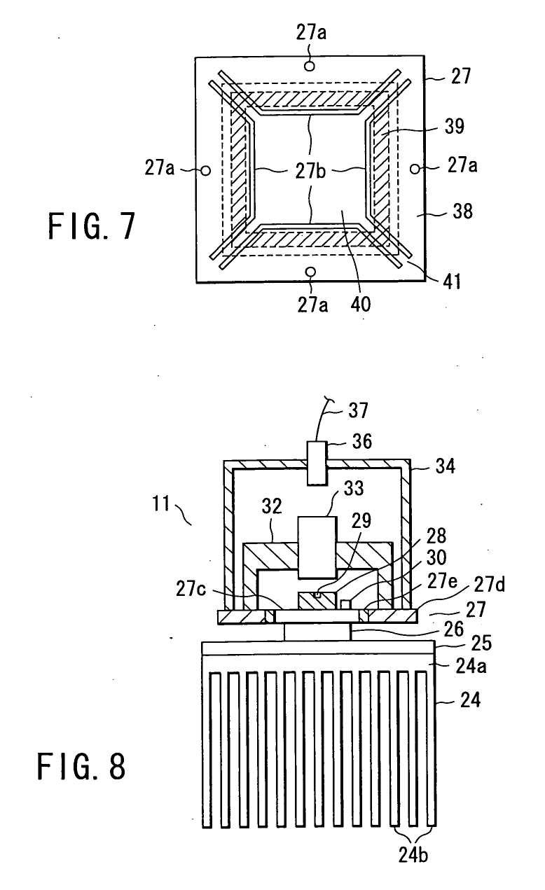

The second heat spreader 27 is so formed as to have a square plate-like configuration as shown in FIG. 7. In the second heat spreader 27, four elongated holes 27b are formed parallel to four sides of the square such that both end portions of each elongated hole extend as if being folded toward the corresponding corners of the square.

The second heat spreader 27 has a central portion 40 on one surface side, that is, square-like portion 40 situated inside the elongated holes 27b, the square-like portion 40 making contact with the Peltier element 26 of a substantially similar configuration.

Further, the holder 32 and casing 34 are formed to be square and tube-like. The holder 32 and casing 34 are set in contact with the other surface side of the second heat spreader 27 at the places situated outside the parallel areas of the elongated holes 27b corresponding to the four sides of the heat spreader 27.

That is, in FIG. 7, the casing 34 is set in contact with the other surface side of the second heat spreader 27 at that area 38 including the marginal edge portion of the heat spreader 27. Further, the holder 32 is set in contact with the second heat spreader 27 at the area corresponding to a cross-hatched area 39 situated inside the area 38.

According to the structure as set out above, the conduction of heat from the holder 32 and casing 34 through the second heat spreader 27 to the Peltier element 26 is prevented by the elongated holes 27b and it is done through leg portions 41 extending from the four corners to the central portion 40 of the second heat spreader 27.

The leg section 41 is smaller in cross-section and has a longer rod-like configuration and a higher heat resistance. Therefore, the leg section 41 can more preferentially absorb the heat of the semiconductor laser element 29 and mount 28 into the Peltier element 26 than the heat of the optical system.

Further, according to this structure, the second heat spreader 27 is such that its area other than its central area 40 belongs to the optical system side. Therefore, the heat capacity of a heat path from the semiconductor laser element 29 to the Peltier element 26 is made smaller, so that rapid cooling can be achieved down to a predetermined operation temperature level.

An explanation will now be made about a third embodiment of the present invention. The third embodiment shows another practical form according to which the heat of the semiconductor laser element 29 and mount 28 is more preferentially transmitted than the heat of the optical system.

With reference to FIG. 8, an explanation will be made below with the same reference numerals employed to designate parts or elements corresponding to those shown in FIG. 6. That is, a second heat spreader 27 made of one sheet comprises a central portion 27c on which a Peltier element 26, mount 28 for the semiconductor laser element 29 and temperature sensor 30 are mounted, an outer peripheral portion 27d with a holder 32 and casing 34 mounted thereon, and a high heat resistance element 27e of a frame-like configuration connecting the central portion 27c to the outer peripheral portion 27d.

Also in this structure, the transmission of the heat from the holder 32 and casing 34 into the Peltier element 26 is prevented by the high heat resistance element 27e. Therefore, the heat of the semiconductor laser element 29 and mount 28 can be more preferentially transmitted than the heat of the optical system.

The present invention is not restricted to the above-mentioned embodiments, and various changes or modifications of the constituent elements can be made without departing from the essence of the present invention at a practical stage. For example, some elements can be eliminated from all the constituents shown in the respective embodiments. Further, the constituent elements of the different embodiments may be properly combined together.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor laser module comprising:
a semiconductor laser element;
an electronic cooling element configured to allow heat from the semiconductor laser element to be transmitted thereto;
a heat sink configured to allow the heat which is transmitted to the electronic cooling element to be released;
an optical system configured to conduct a laser beam which is emitted from the semiconductor laser element to an optical fiber cable; and
a heat resistance section configured to transmit the heat of the optical system to the electronic cooling element, having a heat resistance greater than a heat resistance when the heat of the semiconductor laser element is transmitted to the electronic cooling element.

2. A semiconductor laser module according to claim 1, wherein said heat resistance section is configured to interpose a heat resistance element between the optical system and the electronic cooling element, the heat resistance element having a heat resistance greater than a heat resistance when the heat of the semiconductor laser element is transmitted to the electronic cooling element.

3. A semiconductor laser module according to claim 1, wherein said heat resistance section includes a heat spreader having a first area configured to allow the heat of the semiconductor laser element to be transmitted thereto and allow that heat to be transmitted to the electronic cooling element, and a second area configured to allow the heat of the optical system to be transmitted thereto, wherein said heat resistance section is provided by forming a high heat resistance portion between the first area and the second area at the heat spreader, the high heat resistance portion being formed as a hole.

4. A semiconductor laser module according to claim 1, wherein said heat resistance section includes, as an integral member, a first portion configured to allow the heat of the semiconductor laser element to be transmitted thereto and allow that heat to be transmitted to the electronic cooling element, a second portion configured to allow the heat of the optical system to be transmitted thereto and a third portion interposed between the first portion and the second portion and configured to have a heat resistance greater than that of the first portion.

5. A semiconductor laser module according to claim 1, wherein said optical system includes an optical coupling system configured to optically couple together the semiconductor laser element and optical fiber cable, a holder configured to support the optical coupling system and transmit heat to the heat resistance section, and a casing configured to support the optical fiber cable and transmit heat to the heat resistance section.

6. A semiconductor laser module according to claim 5, wherein the portions of the holder and casing which make contact with the heat resistance section are so formed as to be symmetrical about an optical axis of the optical coupling system and optical fiber cable.

7. A semiconductor laser module according to claim 1, further comprising a first heat spreader configured to transmit heat from the electronic cooling element to the heat sink and a second heat spreader configured to transmit heat from the semiconductor laser element and heat resistance section to the electronic cooling element.

8. A method for releasing heat from a semiconductor laser module configured to allow heat of a semiconductor laser element, as well as heat of an optical system configured to conduct a laser beam which is emitted from the semiconductor laser element to an optical fiber cable, to be released through an electronic cooling element to a heat sink, comprising:
detecting a temperature of the semiconductor laser element;
turning the electronic cooling element ON in a state in which the detected temperature of the semiconductor laser element is higher than a steady-state operation temperature;
at a starting time of carrying electric current to the electronic cooling element, absorbing the heat of the semiconductor laser element into the electronic cooling element in preference to the heat of the optical system; and
driving the semiconductor laser element in a state in which the temperature of the semiconductor laser element reaches the steady-state operation temperature.

9. An image display apparatus comprising:
a semiconductor laser module configured to allow heat of a semiconductor laser element to be released through an electronic cooling element to a heat sink and allow heat of an optical system to be transmitted to the electronic cooling element through a heat resistance section having a heat resistance greater than a heat resistance when the heat of the semiconductor laser element is transmitted to the electronic cooling element, the optical system being configured to allow a laser beam which is emitted from the semiconductor laser element to be conducted to an optical fiber cable;
a modulation section configured to space-modulate a laser beam which is outputted through the optical fiber from the semiconductor laser module on the basis of a video signal; and
a display section configured to projection-display the light output which is obtained from the modulation section onto a screen.

10. An image display apparatus according to claim 9, wherein the semiconductor laser module and modulation section are so provided as to correspond to each of R, G, B laser beams and the display section synthesizes outputs from respective modulation sections corresponding to the R, G, B signals and projects a synthesized output onto the screen.

11. An image display apparatus according to claim 9, wherein the video signal is obtained by demodulating a received TV broadcasting signal.
